(19) United States
(12) Patent Application Publication
(10) Pub. No.: US 2010/0249963 A1
(43) Pub. Date: Sep. 30, 2010

(54) RECORDING SYSTEM FOR SALVAGING INFORMATION IN RETROSPECT

(75) Inventors: Eran Saar, Givatayim (IL); Assaf Talmudi, Or-Yehuda (IL); Yaacov Dunietz, Savyon (IL); Izhak Tzuk-Ramon, Haifa (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: RECOLLECT LTD., Savyon (IL)

(21) Appl. No.: 12/666,836

(22) PCT Filed: Jun. 24, 2008
(86) PCT No.: PCT/IL08/00857

§ 371 Date: Jun. 21, 2010

(30) Foreign Application Priority Data
Jun. 25, 2007 (IL) 184203
Jun. 25, 2007 (IL) 184204

(51) Int. Cl. G06F 17/00; G06F 7/00

(52) U.S. Cl. 700/94; 707/640; 707/E17.101

(57) ABSTRACT

A system for salvaging information and storing the same comprises at least one non-dedicated input device for acquiring information, a nondedicated data storage capable of storing said acquired information, a buffer for storing said acquired information, a media file for storing all or portions of said acquired information of said buffer, a non-dedicated host, for communicating with said device(s) and said storage, capable of receiving said acquired information from said device(s) and storing said acquired information in said buffer, and capable of retrieving said portions of acquired information from said buffer and storing said portions in said media file; and dedicated software to operate said nondedicated device, data storage and host and to save data acquired by said at least one input device during a selected, previous period of time.

### REFERENCE TO CO-PENDING APPLICATIONS

Priority is claimed as a continuation-in-part from a 371 of international of PCT/IL2008/000857, filed on Jun. 24, 2008, which claims priority to Israeli patent application numbers 184203, filed on Jun. 25, 2007 and 184204, filed on Jun. 25, 2007.

### FIELD OF THE INVENTION

The present invention relates to the field of recording systems. More particularly, the invention relates to a system for retroactively selecting and saving information of past events that have not been preselected for saving.

### BACKGROUND OF THE INVENTION

As of today many systems and devices exist for recording events and occasions, in video and/or audio, such as: tape recorders, video-recorders, camcorders, etc. However, existing devices require a pre-event trigger to activate, meaning, that the user is required to operate them before the beginning of the event. For example, in order to record a conversation, the user is required to know beforehand that the conversation is going to be important and therefore it is worthwhile to record. Once the user decides it should be recorded, he is required to set the recorder to record from the beginning of the conversation. However, in real-life, many important events occur without prior warning, where one finds himself at the end of events, wishing he could save a recording of the passing event. Therefore, it is most desirable for many people to be able to save recordings of events after they have already occurred.

Dedicated devices are also known in the art, which continuously record information. When it is desired to use a segment of such information, it must be located off-line, edited out of the complete recorded information, and then further processed. Such prior art devices are inconvenient to use, both because the user must decide beforehand to take them with him, and because of the inconvenient data processing methods described above. Thus, although a number of such devices have been suggested in the art, they have not achieved commercial success.

Examples of such devices include, e.g., US 2006/0158968 that discloses a video surveillance system adapted to be mounted in a law enforcement vehicle for producing a permanent digital evidentiary record of events and incidents occurring after a suspect's vehicle has been stopped. However, the described video surveillance system starts the evidentiary record only after receiving an external start trigger.

WO 00/17822 discloses a system that comprises one or more cameras placed at points on a vehicle for viewing the space through which the vehicle moves, and a recording device with a storage circuit for recording the images photographed by the cameras. The storage circuit continuously substitutes the recorded images, from the most remote ones onwards. The disclosed system also comprises a circuit for reading the recorded images. Nevertheless, the disclosed system continues recording indiscriminately until an accident has occurred or until the storage circuit is read. The publication does not describe a way to allow a user to select and store certain events after they occurred while continuing recording.

As will be apparent to the skilled person, existing devices, such as PC, PDA, etc. are already provided with input hardware, such as microphone and camera, which however, are not continuously exploited.

It is an object of the present invention to provide a system which is capable of providing recorded data of an event in retrospect, after the event occurred, without initiating a recording before the specific event and without the need for dedicated apparatus.

It is another object of the present invention to provide a system which allows the user to decide, at the end of the event, the duration of the meaningful part of the event, prior to saving it.

It is still another object of the present invention to provide a system which is capable of providing recorded data concerning a past event in response to a trigger automatically generated after the event.

Other objects and advantages of the invention will become apparent as the description proceeds.

### SUMMARY OF THE INVENTION

The present invention relates to a system for salvaging information and storing the same comprising: (a) at least one non-dedicated input device for acquiring information; (b) a non-dedicated data storage capable of storing said acquired information; (c) a buffer for storing said acquired information, where the buffer can be provided as part of the host or can be found in a remote data storage in communication herewith, for instance over a WAN or LAN; (d) a media file for storing all or portions of said acquired information of said buffer, where by “media file” it is meant to include any file containing video and/or audio and/or image data whether directly playable/visible by a media player/viewer, or whether such data requires transformation to become playable/viewable by a media player/viewer; (e) a non-dedicated host, for communicating with said device(s) and said storage, capable of receiving said acquired information from said device(s) and storing said acquired information in said buffer, and capable of retrieving said portions of acquired information from said buffer and storing said portions in said media file; and (f) dedicated software to operate said non-dedicated device, data storage and host and to save data acquired by said at least one input device during a selected, previous period of time.

The term “non-dedicated” in the context of this invention, refers to an element or a device which, in the course of the conventional use of the apparatus or apparatuses that comprise them, is not provided for the purpose of the invention.

According to a preferred embodiment of the invention the input device is a camcorder.

In another preferred embodiment the input device is a microphone.

In a further preferred embodiment the input device is a display screen, and the input is the displayed information.

In still another preferred embodiment the host is a personal computer.

Many non-dedicated devices are suitable to carry out the invention. Examples of hosts are: an electronic notebook, a mobile computer (laptop), a PDA and a mobile phone.

Examples of storage devices are: a hard disk, a flash memory device and a volatile memory device, such as dynamic RAM.

According to a preferred embodiment of the invention the input device is an integral component of the host.

In another preferred embodiment the storage is an integral component of the host.

In a further preferred embodiment, the use of an input device of a host is used as an input to the system.

Illustrative examples of input devices are: a microphone, a video or stills camera, or a display.

The invention further relates to a method for salvaging information and storing the same comprising the steps of: (a) providing at least one non-dedicated input device for acquiring information; (b) providing a non-dedicated data storage capable of storing said acquired information; (c) allocating a buffer in said storage for storing said acquired information; (d) providing a media file for storing portions of said acquired information of said buffer; (e) providing a non-dedicated host, for communicating with said device(s) and said storage, capable of receiving said acquired information from said device(s) and storing said acquired information in said buffer, and capable of retrieving said portions of said acquired information from said buffer and storing said portions in said media file; (f) continuously storing said acquired information from said input device(s) in said buffer; and (g) generating a request for a portion of said acquired information and upon said request, retrieving said portion from said buffer and storing said portion in said media file.

In order to carry out the invention suitable software is provided to operate the non-dedicated device according to the invention. Said software will include, inter alia, a simple user interface to input commands representative of the time segment of the information that it is desired to save, and to select and save it. Providing such software is well within the scope of the skilled person and is therefore not described in detail for the sake of brevity.

### BRIEF DESCRIPTION OF THE DRAWINGS

In the drawings:

FIG. 1 is a schematic illustration of the system according to an embodiment of the invention;

FIG. 2 is a flow chart generally illustrating an embodiment of the process of the invention for continuously receiving data from the input devices; and

FIG. 3 is a flow chart generally illustrating the method of salvaging and saving the recorded data according to an embodiment of the invention.

### DETAILED DESCRIPTION OF PREFERRED EMBODIMENTS

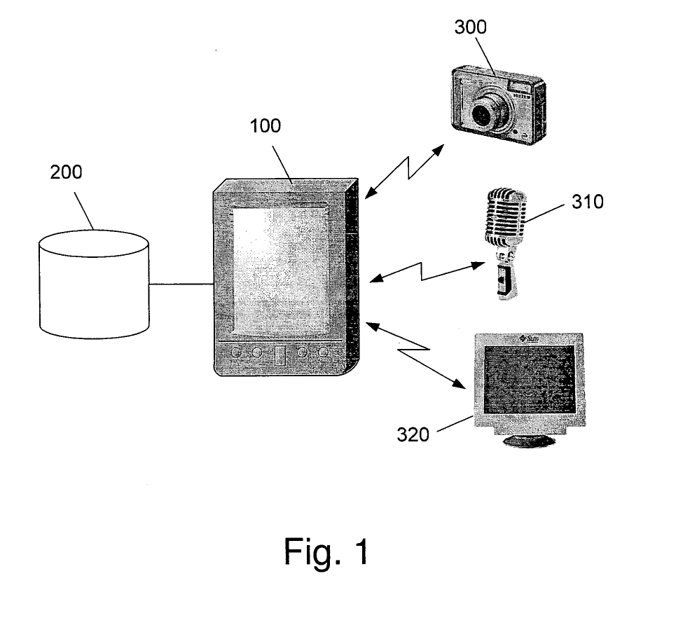

FIG. 1 is a schematic illustration of the system according to an embodiment of the invention. The non-dedicated host system 100, which may be, for example, a personal computer, an electronic notebook, a mobile computer, a PDA, a mobile phone, or any other processing system capable of receiving and processing data, is responsible for receiving continuous recording data and storing it. At first the host 100 scans for available input devices. Available input devices may be camcorders such as camcorder 300, microphone 310, display 320, or any other input device whether it is an outer device, such as a computer attached video camera, communicating with the host 100 and whether it is an integral part of the host 100 such as a built-in microphone. Host 100 may communicate with input devices through internal communication busses, Wireless communication, Infrared, Bluetooth, wired communication, or any other communication means and protocols. When host 100 receives data from the devices it stores the data in a buffer on storage device 200. Storage 200 may be a hard disk, flash memory device, dynamic RAM, or any other data storage device. The storage 200 may be an outer storage device communicating with the host 100 or storage 200 may be an integral part within host 100. Thus the recorded data received from devices such as devices 300, 310, and 320 is continuously stored by host 100 on storage 200. In one of the embodiments, the recorded data may be compressed before storage.

The input devices may comprise any device that channels information actively or passively. An example of an active device may be: digital video cameras, recorders, microphones, MP3 recorders, etc. whereas passive input devices may comprise a display, where the displayed information is communicated to the host.

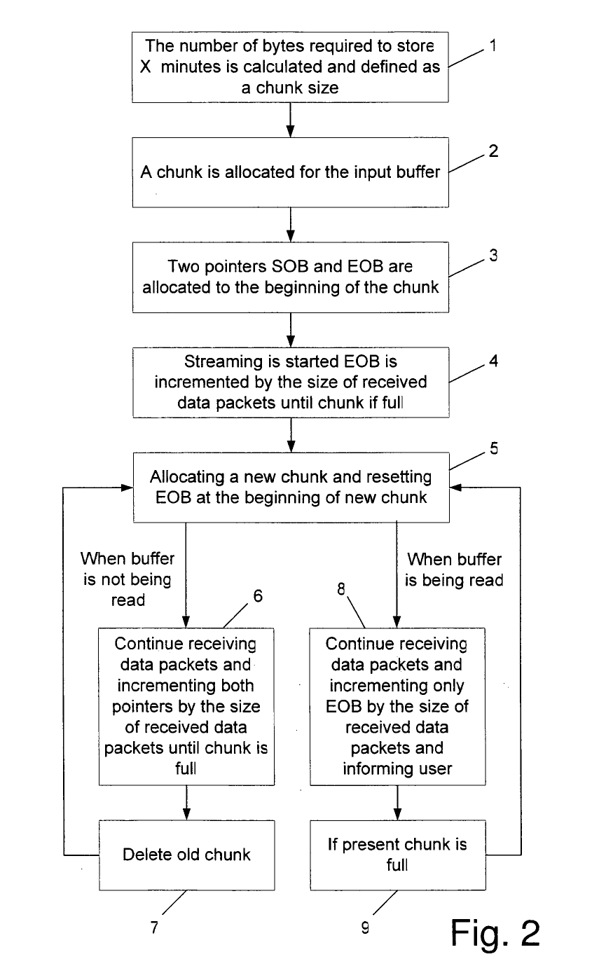

FIG. 2 is a flow chart generally illustrating our preferred embodiment of the invention. For the sake of brevity the following steps are described for only one input device, however, as understood many devices may be connected to the same host, where the following steps are repeated for each input device separately. Once the host 100, as described in relations to FIG. 1, has established communications with the input device, then in step 1, a data size “chunk” is defined. A data “chunk” is defined as a data size for storing X number of recorded minutes from the input device. The X number of recorded minutes may be user defined or predefined. For example, if an input device supplies 1 megabyte data per minute, and if the user-defined number of recorded minutes is 30, then a chunk of data is defined as 30 megabytes. In step 2 the host 100 allocates a chunk of data on storage 200 for the buffer for the input device, which stores the incoming recorded data. In step 3 two pointers are allocated for the buffer: Start Of Buffer (SOB) and End Of Buffer (EOB), for delimiting the valid data in the buffer. At this starting stage, both pointers SOB and EOB are set to point to the beginning of the allocated chunk. In step 4, the streaming of recorded data from the input devices may be started, where the EOB is incremented by the size of the received data packets. In this manner the EOB always points at the end of the valid data in the buffer. Streaming of data may be continued until the chunk is “full”, meaning, that the received data packets have filled the chunk size and the EOB points to the end of the allocated chunk. In step 5 a new chunk is allocated for the buffer and the EOB is reset to point at the beginning of the new chunk. The system may operate in two modes. The first mode is when the buffer is not being read at the present, and the second mode is when the buffer is presently being read. In both modes the streaming continues and the received data packets are stored in the buffer, however, when the buffer is not being read, in step 6 both pointers SOB and EOB are equally incremented with the size of the received data packets. Thus the streaming continues until the new chunk is full. When the new chunk is full and the SOB is pointing to the end of the old chunk then in step 7 the old chunk is deleted, SOB is reset to point at beginning of the new chunk, and another newer chunk is allocated as described in relation to step 5. Thus steps 5 to 7 may be repeated many times, always storing the last X minutes of recorded data. In the second mode, when the buffer is presently being read, the streaming continues and the received data packets are stored in the new chunk, however, only the EOB pointer is incremented with the size of the received data packets. Thus the streaming continues until the new chunk is full. In step 9 when the new chunk is full and the EOB points at the end of the chunk, then another newer chunk is allocated as described in relations to step 5. Thus steps 5, 8 and 9 may be repeated until a signal is received that the buffer is not being read anymore. When the buffer has is not read, the SOB is incremented to point to the place in the buffer lagging a chunk behind BOB, and all the chunks that are no longer delimited by the pointers are discarded. From this point on, the process continues in the mode where the buffer is not presently being read as described in relations to steps 5 to 7.

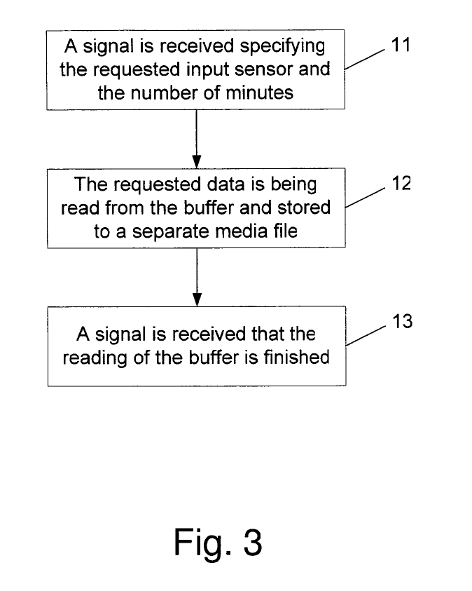

FIG. 3 is a flow chart generally illustrating the method of salvaging and saving the recorded data according to a preferred embodiment of the invention. In step 11 a signal starts the process of retrieving a past recorded event. The signal can be produced by a human operator, such as the user, requesting to save a certain past event, or can be produced automatically in response to a predefined condition. The described signal, for retrieving and storing an event, may specify the requested input device(s) and the duration to store, such as: the starting time of the event and/or the duration of the event and/or the ending time of the event. For example, the user may wish to retrieve and store the video stream from a camera positioned in his home which has just filmed the first steps of his child. In this example, the user produces a signal which requests to save last 5 minutes of the camera stream. The signal of step 11 is produced during the continuous operation of the system as described in relation to FIG. 2, and may be received by the system during any one of the steps 4 to 9 described in relations to FIG. 2. In step 12, after the signal has been received, the requested data is read from the buffer and stored in a separate media file. The separate media file may be stored on separate storage such as a different hard disk or optical disk, or the separate media file may be stored in the same storage of the buffer, in the host, or on any other media file. In step 13, after the requested recording has been saved, another signal is sent to the system that the reading of the buffer has been finished. Thus the requested information has been saved and stored after the event had occurred.

According to another embodiment, whenever the user identifies important information, he activates the process of retrieving a past or new recorded event from the buffer and storing it in a separate media file. However, he may decide that the current and upcoming audio information are important and must be saved, as well. In this case, the application will store the future information in a separate buffer and will append it to the saved past recorded event, until receiving another signal from the user to terminate this session. In addition, the recording application may be appended to an email application, so as to send the user an email with the recorded audio file as an attachment. Similarly, the recording application may be implemented also to video files or other types of files that have been retrieved. The user may upload these files to the internet via one of his social networks (e.g., Twitter or FaceBook) or to a website (e.g., YouTube).

According to another embodiment, data related to a specific segment may be saved while keeping its context by adding the name and phone number of the other participant(s) in a recorded segment, so as to better distinguish between recorded segments. If the hosting device includes a GPS, it is also possible to add the location of the user along with the record. Also, the user can save a title of a meeting and participants information if this information exists in the relevant application in the device (a laptop or a mobile phone), such as Calendar, Outlook or contact list.

In order to save storage space in the buffer, it is possible to add a filtering feature to the application that will allow recording and saving only audio data that is related to human speech, while excluding other voices that are considered to be background noise. This discrimination (that may be achieved using audio frequency analysis) helps saving battery power by eliminating sampling or storing of such a background noise. It also increases the quality of recording of the segment of interest.

An additional feature may include lowering the sampling rate of the sensors when the background noise is constant or when the hosting device is in a relatively quiet environment when there is no speech (for example, in an empty room or at night time), in order to save battery power. It is also possible to disable any recording in the buffer, as long as there is no significant difference between samples (e.g., every 1 Sec). The sensors may also be of any type of human sense like sensor, which is included in the host device (such as video sensor, camera and screen shots).

According to another embodiment, the user may activate the process of retrieving a past recorded event from the buffer and storing it in a separate media file by voice commands. The user may record in advance several words or short sentences (audio string) that will be recognized by a voice recognition application in the audio device. Such words or short sentences may include, for example, the keyword “important” or “phone remember that”, “phone memo” (saving forward memo), etc. When such an audio string will be identified, recording and saving will start automatically.

While some embodiments of the invention have been described by way of illustration, it will be apparent that the invention can be carried into practice with many modifications, variations and adaptations, and with the use of numerous equivalents or alternative solutions that are within the scope of persons skilled in the art, such as carrying out the invention in musical instruments rather than in communication devices, without departing from the spirit of the invention or exceeding the scope of the claims.

1. A system for salvaging information and storing the same comprising:
a. at least one non-dedicated input device for acquiring information;
b. a non-dedicated data storage capable of storing said acquired information;
c. a buffer for storing said acquired information;
d. a media file for storing all or portions of said acquired information of said buffer;
e. a non-dedicated host, for communicating with said device(s) and said storage, capable of receiving said acquired information from said device(s) and storing said acquired information in said buffer, and capable of retrieving said portions of acquired information from said buffer and storing said portions in said media file; and
f. dedicated software to operate said non-dedicated device, data storage and host and to save data acquired by said at least one input device during a selected, previous period of time.

2. A system according to claim 1, where the input device is a camcorder.

3. A system according to claim 1, where the input device is a microphone.

4. A system according to claim 1, where the input device is a display screen, and the input is the displayed information.

5. A system according to claim 1, where the host is a personal computer.

6. A system according to claim 1, where the host is an electronic notebook.

7. A system according to claim 1, where the host is a mobile computer.

8. A system according to claim 1, where the host is a PDA.

9. A system according to claim 1, where the host is a mobile phone.

10. A system according to claim 1, where the storage is a hard disk.

11. A system according to claim 1, where the storage is a flash memory device.

12. A system according to claim 1, where the storage is a volatile memory device, such as dynamic RAM.

13. A system according to claim 1, where the input device is an integral component of the host.

14. A system according to claim 1, where the storage is an integral component of the host.

15. A method for salvaging information and storing the same comprising the steps of:
a. providing at least one non-dedicated input device for acquiring information;
b. providing a non-dedicated data storage capable of storing said acquired information;
c. allocating a buffer in said storage for storing said acquired information;
d. providing a media file for storing portions of said acquired information of said buffer;
e. providing a non-dedicated host, for communicating with said device(s) and said storage, capable of receiving said acquired information from said device(s) and storing said acquired information in said buffer, and capable of retrieving said portions of said acquired information from said buffer and storing said portions in said media file;
f. continuously storing said acquired information from said input device(s) in said buffer; and
g. generating a request for a portion of said acquired information and upon said request, retrieving said portion from said buffer and storing said portion in said media file.

16-30. (canceled)

31. A method according to claim 15, further comprising recording important current and upcoming audio information in a separate buffer, until receiving another signal from the user to terminate the session and appending said information to the saved past recorded event.

32. A method according to claim 15, further comprising sending the user an email with the recorded audio file as an attachment.

33. A method according to claim 15, further comprising adding contextual data related to a specific segment that may include:
the name and phone number of the other participant(s) in a recorded segment;
the GPS location data of the user when the record is made;
a title of a meeting and participants information.

34. A method according to claim 15, further comprising a filtering feature for allowing recording and saving only audio data that is related to human speech.

35. A method according to claim 15, wherein the sampling rate of the sensors is lowered and writing into the buffer is disabled when the background noise is constant or when the device is in a relatively quiet environment when there is no speech.

36. A method according to claim 15, wherein the user activates the process of retrieving a past or new recorded event from the buffer and storing it in a separate media file by using voice commands that automatically start recordation.
